(19) United States
(12) Patent Application Publication
(10) Pub. No.: US 2025/0218450 A1
(43) Pub. Date: Jul. 3, 2025

(54) METHODS, APPARATUS AND SYSTEMS FOR USER GENERATED CONTENT CAPTURE AND ADAPTIVE RENDERING

(71) Applicant: Dolby Laboratories Licensing Corporation, San Francisco, CA (US)

(72) Inventors: Yuanxing MA, Beijing (CN); Zhiwei SHUANG, Beijing (CN); Yang LIU, Beijing (CN)

(73) Assignee: Dolby Laboratories Licensing Corporation, San Francisco, CA (US)

(21) Appl. No.: 18/852,701

(22) PCT Filed: Apr. 3, 2023
(86) PCT No.: PCT/US2023/017256

§ 371 Date: Sep. 30, 2024

Related U.S. Application Data
(60) Provisional application No. 63/336,700, filed on Apr. 29, 2022.

(30) Foreign Application Priority Data
Apr. 8, 2022 (WO) PCT/CN2022/085777

(51) Int. Cl. G10L 21/02

(52) U.S. Cl. CPC G10L 21/02

(57) ABSTRACT

Methods of processing audio data relating to user generated content are described. One method includes obtaining the audio data; applying frame-wise audio enhancement to the audio data; generating metadata for the enhanced audio data, based on one or more processing parameters of the frame-wise audio enhancement; and outputting the enhanced audio data together with the metadata. Another method includes obtaining the audio data and metadata for the audio data, wherein the metadata comprises first metadata indicative of one or more processing parameters of a previous frame-wise audio enhancement of the audio data; applying restore processing to the audio data, using the one or more processing parameters, to at least partially reverse the previous frame-wise audio enhancement; and applying frame-wise audio enhancement or editing processing to the restored raw audio data. Further described are corresponding apparatus, programs, and computer-readable storage media.

### CROSS-REFERENCE TO RELATED APPLICATIONS

This application claims the priority benefit of U.S. Provisional Patent Application No. 63/336,700, filed Apr. 29, 2022, and International Application No. PCT/CN2022/085777, filed Apr. 8, 2022, each of which is hereby incorporated in their entireties.

### TECHNICAL FIELD

The present document relates to methods, apparatus, and systems for capture and adaptive rendering of user generated content (UGC). The present document particularly relates to UGC content creation on mobile devices that enables adaptive rendering during playback, and to adaptive rendering during playback.

### BACKGROUND

Recently, UGC has become a trend of personal moment sharing in variable environments. UGC is mostly recorded by mobile devices. Most of this content will have sound artifacts due to consumer hardware limitation, system performance requirements, diversity of capture practices, and playback environment.

To overcome sound quality issues introduced by hardware limitations and recording environment, UGC audio may be enhanced for better listening experience. Certain audio enhancements could be applied in real-time during or immediately after capture, with the information available at that time. Such enhancements can be applied to the audio stream directly and generate enhanced audio streams in real-time. The enhanced audio can then be rendered without specific software support on playback devices. Thereby, UGC content creators could improve audio quality of their content without additional effort and make sure that such enhancement would be available to their content consumers to the greatest extent.

However, there are also audio enhancements that rely on additional information beyond what is available in real-time, for further enhanced audio quality. Moreover, the real-time enhancement following capture may not be compatible with end-to-end content processing and user experience.

Thus, there is a need for improved techniques for UGC capture and adaptive rendering.

### SUMMARY

According to an aspect, a method of processing audio data relating to user generated content is provided. The method may be performed by a mobile device, for example. The method may include obtaining the audio data. Obtaining the audio data may include or amount to capturing the audio data by a suitable capturing device. The capturing device may be part of the mobile device, or may be connected/connectable to the mobile device. Further, the capturing device may be a binaural capturing device, for example, that can record at least two channel recordings. The method may further include applying frame-wise audio enhancement to the audio data to obtain enhanced audio data. The method may further include generating metadata for the enhanced audio data, based on one or more (e.g., a plurality of) processing parameters of the frame-wise audio enhancement. The method may yet further include outputting the enhanced audio data together with the generated metadata.

Configured as described above, the proposed method can provide enhanced audio data that is suitable for direct playback by a playback device, without further audio processing by the playback device. On the other hand, the method also provides context metadata for the enhanced audio data. This context metadata allows to restore the raw audio for additional/alternative audio enhancement by a playback device with different (e.g., better) processing capabilities, or for audio editing with an editing tool. Thereby, rendering at the playback device can be performed in an adaptive manner, depending on the device's hardware capabilities, the playback environment, user-specific settings, etc. In other words, providing the context metadata allows for end-to-end content processing from capture to playback, taking into account characteristics of the specific capture and rendering hardware, specific environments, user preferences, etc., thereby enabling optimal enhancement of the audio data and listening experience.

In some embodiments applying the frame-wise audio enhancement to the audio data may include applying at least one of: noise management, loudness management, timbre management, and peak limiting. Here, noise management may relate to de-noising, for example. Loudness management may relate to level adjustment and/or dynamic range control, for example.

By such processing the enhanced audio data is suitable for direct replay by a playback device without additional audio processing at the playback device. As such, the UGC generated by the proposed method is particularly applicable to being consumed by mobile devices with typically limited processing capabilities, for example in a streaming framework for devices without specific software support for reading metadata. On the other hand, if the device in the streaming framework has specific software support for reading the metadata, the metadata and enhanced audio data may be read, raw audio may be generated/restored from the enhanced audio data using the metadata, and further enhanced audio may be generated based on the raw audio.

In some embodiments, the one or more processing parameters may include band gains and/or full-band gains applied during the frame-wise audio enhancement. The band gains or full-band gains may comprise respective gains for each frame of the audio data. Further, the band gains or full-band gains may comprise respective gains for each type of enhancement processing that is applied. The metadata may include the actual gains or indications thereof.

Accordingly, in some embodiments, the one or more processing parameters may include at least one of: band gains for noise management, full-band gains for loudness management, band gains for timbre management, and full-band gains for peak limiting. Being aware of these gains, a device (e.g., playback device, editing device) receiving the enhanced audio data can reverse any enhancement processing applied after capture, if necessary, to subsequently apply different audio enhancements and/or audio editing.

In some embodiments, the frame-wise audio enhancement may be applied in real time. That is, the frame-wise audio enhancement may be real-time frame-wise audio enhancement. The enhanced audio data generated in this manner would be particularly suitable for streaming applications or the like.

In some embodiments, the metadata may be generated further based on a result of analyzing multiple frames of the audio data. In some embodiments, the analysis of multiple frames of the audio data may yield long-term statistics of the audio data. The long-term statistics may be file-based statistics, for example. Additionally or alternatively, the analysis of multiple frames of the audio data may yield one or more audio features of the audio data.

In some embodiments, the audio features of the audio data may relate to at least one of: a content type of the audio data, an indication of a capturing environment of the audio data, a signal-to-noise ratio of the audio data, an overall loudness of the audio data, and a spectral shape of the audio data. The overall loudness of the audio data may relate to a file loudness, for example. The spectral shape may relate to a spectral envelope, for example.

Including such additional information in the metadata enables any devices receiving the enhanced audio data and the metadata to perform more sophisticated audio enhancements that may not be possible in real time and/or to perform audio enhancement adapted to specific use cases, environments, etc.

In some embodiments, the metadata may include first metadata generated based on the one or more processing parameters of the frame-wise audio enhancement and second metadata generated based on the result of analyzing multiple frames of the audio data. Then, the method may further include compiling the first and second metadata to obtain compiled metadata as the metadata (context metadata) for output. The first metadata may be referred to as enhancement metadata, for example. The second metadata may be referred to as long-term metadata, for example.

According to another aspect, a method of processing audio data relating to user generated content is provided. The method may include obtaining the audio data. The method may further include obtaining metadata for the audio data. Therein, the metadata may include first metadata indicative of one or more processing parameters of a previous (earlier; e.g., capture side) frame-wise audio enhancement of the audio data. Obtaining the audio data and the metadata may include or amount to receiving a bitstream comprising the audio data and the metadata, including retrieving the audio data and the metadata from a storage medium, for example. The method may further include applying restore processing to the audio data, using the one or more processing parameters, to at least partially reverse the previous frame-wise audio enhancement, thereby obtaining raw audio data. The method may yet further include applying frame-wise audio enhancement to the raw audio data to obtain enhanced audio data. Additionally or alternatively, the method may include applying editing processing to the raw audio data to obtain edited audio data.

By restoring the raw audio data, a replay/editing device can apply audio enhancement or audio editing depending on its processing capabilities, user preferences, playback environment, long term statistics, etc. Thereby, end-to-end content processing and optimum user experience can be achieved. On the other hand, if processing capabilities should not be sufficient for audio enhancement, the received enhanced audio data can be directly rendered without additional processing.

In some embodiments, applying the restore processing to the audio data includes applying at least one of: ambiance restoring, loudness restoring, peak restoring, and timbre restoring. Here, it is understood that noise management/noise suppression may suppress ambiance sound as noise, depending on the definition of “noise” and “ambiance”. For instance, footsteps could belong to noise if speech is the main interest, but could belong to ambiance, if thought of as part of the soundscape. Thus, in restore processing, reference is made to “ambiance” restoring for reversing or partially reversing noise management.

In some embodiments, the one or more processing parameters may include band gains and/or full-band gains applied during the previous frame-wise audio enhancement. Thus, in some embodiments, the one or more processing parameters may include at least one of: band gains of previous noise management, full-band gains of previous loudness management, full-band gains of previous peak limiting, and band gains of previous timbre management.

In some embodiments, the metadata may further include second metadata indicative of long-term statistics of the audio data and/or indicative of one or more audio features of the audio data. The statistics of the audio data and/or the audio features of the audio data could be based on the audio prior to or after the previous frame-wise audio enhancement, or even to audio data between two successive previous frame-wise audio enhancements, if applicable.

In some embodiments, the audio features of the audio data may relate to at least one of: a content type of the audio data, an indication of a capturing environment of the audio data, a signal-to-noise ratio of the audio data prior to the previous frame-wise audio enhancement, an overall loudness of the audio data prior to the previous frame-wise audio enhancement, and a spectral shape of the audio data prior to the previous frame-wise audio enhancement.

In some embodiments, applying the frame-wise audio enhancement to the raw audio data may be based on the second metadata. Thereby, more sophisticated audio enhancement processing than real-time enhancement can be applied, thereby improving the listening experience.

In some embodiments, applying the frame-wise audio enhancement to the raw audio data may include applying at least one of: noise management, loudness management, peak limiting, and timbre management.

According to another aspect, an apparatus for processing audio data relating to user generated content is provided. The apparatus may include a processing module for applying frame-wise audio enhancement to audio data to obtain enhanced audio data, and for outputting the enhanced audio data. The apparatus may further include an analysis module for generating metadata for the enhanced audio data, based on one or more processing parameters of the frame-wise audio enhancement, and for outputting the metadata. In addition, the apparatus may further include a capturing module for capturing the audio data.

In some embodiments, the processing module may be configured to apply, to the audio data, at least one of: noise management, loudness management, peak limiting, and timbre management.

In some embodiments, the one or more processing parameters may include band gains and/or full-band gains applied during the frame-wise audio enhancement.

In some embodiments, the one or more processing parameters may include at least one of: band gains for noise management, full-band gains for loudness management, full-band gains for peak limiting, and band gains for timbre management.

In some embodiments, the processing module may be configured to apply frame-wise audio enhancement in real-time.

In some embodiments, the analysis module may be configured to generate the metadata further based on a result of analyzing multiple frames of the audio data. In some embodiments, the analysis of multiple frames of the audio data may yield long-term statistics of the audio data. In some embodiments, the analysis of multiple frames of the audio data may yield one or more audio features of the audio data.

In some embodiments, the audio features of the audio data may relate to at least one of: a content type of the audio data, an indication of a capturing environment of the audio data, a signal-to-noise ratio of the audio data, an overall loudness of the audio data, and a spectral shape of the audio data.

In some embodiments, the analysis module may be configured to generate first metadata based on the one or more processing parameters of the frame-wise audio enhancement and to generate second metadata based on the result of analyzing multiple frames of the audio data. The analysis module may be further configured to compile the first and second metadata, to thereby obtain compiled metadata as the metadata for output.

According to another aspect, an apparatus for processing audio data relating to user generated content is provided. The apparatus may include an input module for receiving audio data and metadata for the audio data. Therein, the metadata may include first metadata indicative of one or more processing parameters of a previous frame-wise audio enhancement of the audio data. The apparatus may further include a processing module for applying restore processing the audio data, using the one or more processing parameters, to at least partially reverse the previous frame-wise audio enhancement, thereby obtaining raw audio data. The apparatus may yet further include at least one of a rendering module and an editing module. The rendering module may be a module for applying frame-wise audio enhancement to the raw audio data to obtain enhanced audio data. The editing module may be a module for applying editing processing to the raw audio data to obtain edited audio data.

In some embodiments, the processing module may be configured to apply, to the audio data, at least one of: ambiance restoring, loudness restoring, peak restoring, and timbre restoring.

In some embodiments, the one or more processing parameters may include band gains and/or full-band gains applied during the previous frame-wise audio enhancement. Accordingly, in some embodiments, the one or more processing parameters may include at least one of: band gains of previous noise management, full-band gains of previous loudness management, full-band gains of previous peak limiting, and band gains of previous timbre management.

In some embodiments, the metadata may further include second metadata indicative of long-term statistics of the audio data and/or indicative of one or more audio features of the audio data.

In some embodiments, the audio features of the audio data may relate to at least one of: a content type of the audio data, an indication of a capturing environment of the audio data, a signal-to-noise ratio of the audio data prior to the previous frame-wise audio enhancement, an overall loudness of the audio data prior to the previous frame-wise audio enhancement, and a spectral shape of the audio data prior to the previous frame-wise audio enhancement.

In some embodiments, the rendering module may be configured to apply the frame-wise audio enhancement to the raw audio data based on the second metadata.

In some embodiments, the rendering module may be configured to apply, to the raw audio data, at least one of: noise management, loudness management, peak limiting, and timbre management.

According to another aspect, an apparatus for processing audio data relating to user generated content is provided. The apparatus may include a processor and a memory coupled to the processor and storing instructions for the processor. The processor may be configured to perform all steps of the methods according to preceding aspects and their embodiments.

According to a further aspect, a computer program is described. The computer program may comprise executable instructions for performing the methods or method steps outlined throughout the present disclosure when executed by a computing device.

According to another aspect, a computer-readable storage medium is described. The storage medium may store a computer program adapted for execution on a processor and for performing the methods or method steps outlined throughout the present disclosure when carried out on the processor.

It should be noted that the methods and systems including its preferred embodiments as outlined in the present disclosure may be used stand-alone or in combination with the other methods and systems disclosed in this document. Furthermore, all aspects of the methods and systems outlined in the present disclosure may be arbitrarily combined. In particular, the features of the claims may be combined with one another in an arbitrary manner.

It will be appreciated that apparatus features and method steps may be interchanged in many ways. In particular, the details of the disclosed method(s) can be realized by the corresponding apparatus, and vice versa, as the skilled person will appreciate. Moreover, any of the above statements made with respect to the method(s) (and, e.g., their steps) are understood to likewise apply to the corresponding apparatus (and, e.g., their blocks, stages, units), and vice versa.

### BRIEF DESCRIPTION OF THE DRAWINGS

The invention is explained below in an exemplary manner with reference to the accompanying drawings, wherein

FIG. 1 illustrates a conceptual diagram of an example apparatus for UGC processing during/after capture according to embodiments of the disclosure;

FIG. 2 is a flowchart illustrating an example method of UGC processing during/after capture according to embodiments of the disclosure;

FIG. 3 illustrates a conceptual diagram of an example apparatus for UGC processing for rendering;

FIG. 4 illustrates a conceptual diagram of an example apparatus for UGC processing for rendering according to embodiments of the disclosure;

FIGS. 5 is a flowchart illustrating an example method of UGC processing for rendering according to embodiments of the disclosure; and

FIG. 6 illustrates a conceptual diagram of an example computing apparatus for performing techniques according to embodiments of the disclosure.

### DETAILED DESCRIPTION

Broadly speaking, the present disclosure relates to methods, apparatus, and systems for UGC content creation, for example on mobile devices, enabling adaptive rendering based on information available at a playback device, and to methods, apparatus, and systems for UGC adaptive rendering.

Real-time audio enhancement at a capture side can yield enhanced audio content that could be rendered without specific support at a playback device. On the other hand, also more sophisticated audio enhancements exist that rely on additional information beyond what is available in real-time, for further enhanced audio quality. According to techniques described herein, such further audio enhancements can be applied to the audio stream, usually stored as metadata along with the audio stream, after the audio capture and real-time enhancement process is finished. With a playback device capable of reading this metadata, the further audio enhancements could be applied in audio content rendering, or in audio editing. Accordingly, techniques described herein can further improve audio quality of UGC for certain content consumers with specific playback devices capable of reading the metadata, or for all content consumers after editing the content with software tools capable of reading the metadata.

At a conceptual level, a capture and rendering ecosystem according to embodiments of the disclosure may be composed of or characterized by some or all of the following elements:
A binaural capture device that can record at least two channel recordings and a playback device that can render the at least two channel recordings. The recording device and the playback device can be the same device, two connected devices, or two separate devices.
The capture device comprises a processing module for enhancing the captured audio in real time. The processing comprises at least one of level adjustment, dynamic range control, noise management, and timbre management.
The capture device comprises an analysis module for providing long-term or file-based features and context information from the audio recording. The analysis results will be stored as context metadata, alongside the enhanced audio content generated by the processing module.
The metadata comprises frame-by-frame analysis results, which include at least the band gains or full-band gains applied by one or more components of the processing module, as well as file-based global results, which include at least one of the loudness, content type, etc. of the audio, and the context information.
During playback, the rendering is adaptive based on the availability of the context metadata.
In one case, the playback device only has access to the enhanced audio, thus during playback it will render the enhanced audio directly without processing, or process it without the help of context metadata.
In another case, the playback device has access to both the enhanced audio and the context metadata. During playback, the playback device will further process the enhanced audio based on the context metadata, for improved listening experience.
The capture device and/or the playback device may also feature an editing tool. When the editing tool has access to the context metadata, the editing of the enhanced audio would generate comparable results as compared to the editing results of the raw audio.

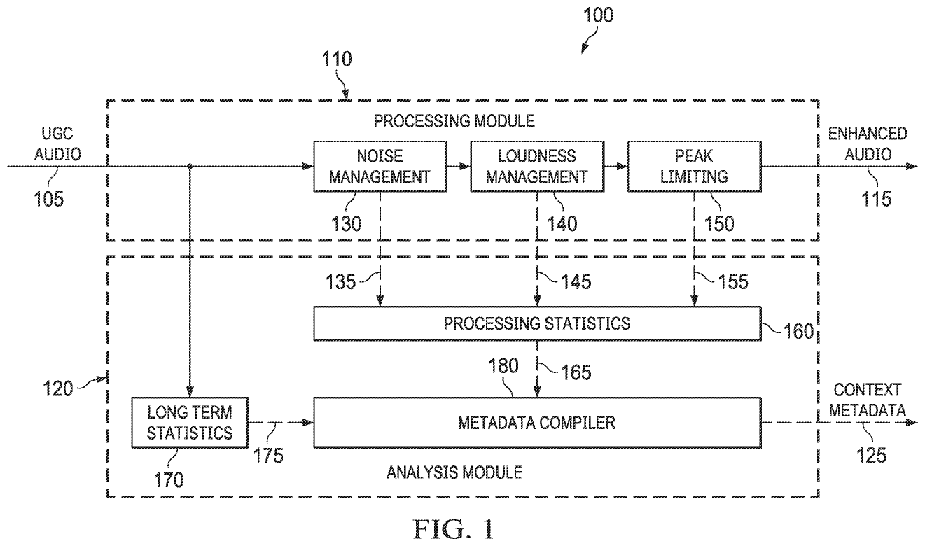

FIG. 1 schematically illustrates an apparatus (e.g., device, system) 100 for processing audio data 105 relating to UGC. Apparatus 100 may relate to a capture side for UGC, and as such may correspond to or be included in a mobile device (e.g., mobile phone, tablet computer, PDA, laptop computer, etc.). Processing performed by apparatus 100 may enable adaptive rendering at a rendering or playback device. The apparatus 100 comprises a processing module 110 and an analysis module 120. Optionally, the apparatus 100 may further comprise a capturing module for capturing the audio data 105 (not shown). The capturing module (or capturing device) may be a binaural capturing device, for example, that can record at least two channel recordings.

The processing module 110 is adapted to apply frame-wise audio enhancement to the audio data 105. This frame-wise audio enhancement may be applied in real time, that is, during or immediately following capture of the UGC. As a result of the frame-wise audio enhancement, enhanced audio data 115 is obtained and output by the processing module 110. The processing module 110 may perform the aforementioned audio enhancements, which could be applied in real-time. Thereby, the processing module 110 generates the enhanced audio data 115 (enhanced audio) that could be rendered without specific support at a playback device.

Specifically, the processing module 110 may be configured to apply, to the audio data 105, at least one of noise management, loudness management, peak limiting, and timbre management. Accordingly, the processing module 110 in the example apparatus 100 of FIG. 1 comprises a noise management module 130, a loudness management module 140, and a peak limiting module 150. An optional timbre management module is not shown in the figure. It is noted that not all of the aforementioned modules for audio enhancement may be present, depending on the specific application.

The audio enhancements performed by the processing module 110 may be based on respective processing parameters. For example, there may be distinct (sets of) processing parameters for each of noise management, loudness management, peak limiting, and timbre management, if present. As described in more detail below, the processing parameters include band gains and/or full-band gains that are applied during the frame-wise audio enhancement. The band gains or full-band gains may comprise respective gains for each frame of the audio data. Further, the band gains or full-band gains may comprise respective gains for each type of enhancement processing that is applied.

The noise management module 130 may be adapted for applying noise management, involving suppressing disturbing noises that are oftentimes present in non-professional recording environments. As such, noise management may relate to de-noising, for example. The noise management module 130 may be implemented, for example, by machine learning algorithms or neural networks including recurrent neural networks (RNNs) or convolutional neural networks (CNNs), the implementation details of which are understood to be readily apparent to experts in the field. Further, noise management may involve pitch filtering.

Processing parameters for noise management may include band gains (e.g., a plurality of band gains) for noise management. These band gains may relate to gains in respective ones among a plurality of frequency bands (e.g., frequency subbands). Further, there may be one such band gain per frame and frequency band. In case of pitch filtering, the processing parameters for noise management may include filter parameters for pitch filtering, such as a center frequency of the filter, for example.

The loudness management module 140 may be adapted for applying loudness management, involving leveling of the input audio stream (i.e., the audio data 105) to a certain loudness range. Loudness management may relate to level adjustment and/or range control. For example, the input audio stream may be leveled to a loudness range more suitable for later playback by a playback device. As such, the loudness management may adjust the loudness of the audio stream to an appropriate range for better listening experience.

It may be implemented by automatic gain control (AGC), dynamic range control (DRC), or a combination of the two, the implementation details of which are understood to be readily apparent to experts in the field.

Processing parameters for loudness management may include gains for loudness management. These gains may relate to full-band gains that uniformly apply to the full frequency range, i.e. apply uniformly to the plurality of frequency bands (e.g., frequency subbands). There may be one such gain per frame.

The peak limiting module 150 may be adapted for applying peak limiting, involving ensuring that the amplitude of the input audio after enhancements will not exceed a legitimate range allowed by audio storage, distribution, and/or playback. Implementation details again are understood to be readily apparent to experts in the field.

Processing parameters for peak limiting may include gains for peak limiting. These gains may relate to full-band gains that uniformly apply to the plurality of frequency bands (e.g., frequency subbands). There may be one such gain per frame.

The timbre management module (not shown) may be adapted for applying timbre management, involving adjusting timbre of the audio data 105.

Processing parameters for timbre management may include band gains (e.g., a plurality of band gains) for timbre management. These band gains may relate to gains in respective ones among a plurality of frequency bands (e.g., frequency subbands). Further, there may be one such band gain per frame and frequency band.

The processing module 110 provides one or more (e.g., a plurality of) processing parameters of the frame-wise audio enhancement to the analysis module 120. The processing parameters may be provided in a frame-wise manner. For example, updated values of the processing parameters may be provided for each frame or for each predefined multiple of frames (e.g., for every other frame, once for every N frames, etc.). The processing parameters may include any, some, or all of processing parameters 135 of noise management, processing parameters 145 of loudness management, processing parameters 155 of peak limiting, and processing parameters of timbre management (not shown).

As further input, the analysis module 120 may receive (a version of) the audio data 105.

The analysis module 120 is adapted to generate metadata 125 (context metadata) for the enhanced audio data 115. Generating the metadata 125 is based on the one or more processing parameters of the frame-wise audio enhancement. For example, the metadata 125 may include the processing parameters (e.g., band gains and/or full-band gains) or an indication thereof.

The analysis module 120 is further adapted to output the metadata 125. In other words, the analysis module 120 analyzes the audio data 105 and/or the aforementioned audio enhancements performed by the processing module 110 to generate the context metadata 125 for audio enhancements that rely on additional information beyond the information that is available in real time, for further improved audio quality. The generated context metadata 125 can be utilized by specific playback devices or editing tools for better audio quality and user experience.

Based on the one or more processing parameters of the frame-wise audio enhancement, the analysis module 120 may generate first metadata 165 (e.g., enhancement metadata) as part of the context metadata 125. For example, the first metadata 165 may include the processing parameters or an indication thereof, as noted above.

In addition to the one or more processing parameters of the audio enhancement, the analysis module 120 may generate the context metadata 125 further based on a result of analyzing multiple frames of the audio data 105. Such analysis of multiple frames of the audio data 105 (i.e., an analysis of the audio data 105 over time) may yield long-term statistics (e.g., file-based statistics) of the audio data 105. Additionally or alternatively, the analysis of multiple frames of the audio data 105 may yield one or more audio features of the audio data 105. Examples of audio features that may be determined in this manner include a content type of the audio data 105 (e.g., music, speech, movie, effects, etc.), an indication of a capturing environment of the audio data 105 (e.g., a quiet/noisy environment, an environment with/without echo or reverb, etc.), a signal-to-noise ratio, SNR, of the audio data 105, an overall loudness (e.g., file loudness) of the audio data 105, and a spectral shape (e.g., spectral envelope) of the audio data 105.

Based on the result of analyzing multiple frames of the audio data the analysis module 120 may generate second metadata 175 (e.g., long-term metadata) as part of the context metadata 125. The second metadata 175 may comprise the long-term statistics and/or the audio features, or indications thereof, for example. The first and second metadata 165, 175 may be compiled to obtain compiled metadata as the context metadata 125 for output. It is understood that the context metadata 125 may include any or both of the first metadata 165, based on the one or more processing parameters, and the second metadata 175, based on the analysis of multiple frames of the audio data 105.

In the example of FIG. 1, the analysis module 120 comprises a processing statistics module 160, a long term statistics module 170, and a metadata compiler module 180 (metadata compiler).

The processing statistics module 160 implements the generation of the first metadata 165 based on the one or more processing parameters. It tracks the key parameters of the processing applied in the processing module 110, such that at a later time, for example during playback, the rendering system could have a better estimation of the raw audio (prior to capture side audio enhancement), based on an enhanced audio stream comprising the enhanced audio data 115 (enhanced audio data) and the metadata 125 (context metadata). As such, analysis of the one or more processing parameters of the audio enhancement by the processing statistics module may yield processing statistics of the audio enhancement performed by the processing module 110.

The long term statistics module 170 implements the generation of the second metadata 175 based on the analysis of multiple frames of the audio data 105 (i.e., long-term analysis of the audio data). It analyzes context information of the audio data 105 over a longer time span than allowed in real-time processing, for example over several frames or seconds, or over a whole file. In general, the statistics derived in this manner would be more accurate and stable than real-time statistics.

The metadata compiler module 180 finally gathers information from both the processing statistics module 160 and the long term statistics module 170 (e.g., the first and second metadata 165, 175) and compiles it into a specific format, so that the information can be retrieved at a later time with a metadata parser. In other words, the metadata compiler module 180 compiles the first and second metadata 165, 175 to obtain compiled metadata as the metadata 125 (context metadata) for output.

As a consequence of the above processing, the apparatus 100 outputs the enhanced audio data 115 together with the context metadata 125. The enhanced audio data 115 and the context metadata 125 may be output in a suitable format as an enhanced audio stream, for example. The enhanced audio stream may be used for adaptive rendering on playback devices, depending on the devices' capabilities, as described further below.

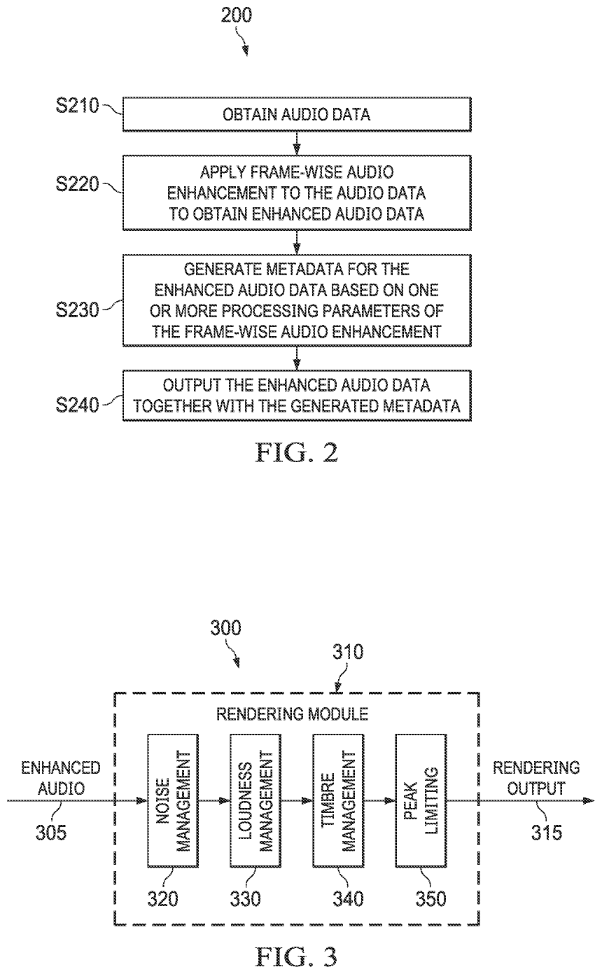

While an example apparatus 100 for UGC processing has been described above, the present disclosure likewise relates to corresponding methods of UGC processing. It is understood that any statements made above with regard to the apparatus 100 likewise apply to corresponding methods, and vice versa. An example of such method 200 of UGC processing (e.g., processing of audio data relating to UGC) is illustrated in the flowchart of FIG. 2. Method 200 comprises steps S210 through S240 and may be performed during/subsequent to capture of the UGC. It may be performed by a mobile device, for example.

At step S210, the audio data is obtained. Obtaining the audio data may include or amount to capturing the audio data by a suitable capturing device. The capturing device may be a binaural capturing device, for example, that can record at least two channel recordings.

At step S220, frame-wise audio enhancement is applied to the audio data to obtain enhanced audio data. This step may correspond to the processing of the processing module 110 described above. In general, applying the frame-wise audio enhancement to the audio data may include applying at least one of noise management (e.g., as performed by the noise management module 130), loudness management (e.g., as performed by the loudness management module 140), peak limiting (e.g., as performed by the peak limiting module 150), and timbre management (e.g., as performed by the timbre management module). Further, the frame-wise audio enhancement may be applied in real time (e.g., during or immediately after capture of the audio data) and may thus be referred to as real-time frame-wise audio enhancement.

At step S230, metadata (context metadata) is generated for the enhanced audio data, based on one or more processing parameters of the frame-wise audio enhancement. This step may correspond to the processing of the analysis module 120 described above. Accordingly, the one or more processing parameters may include band gains and/or full-band gains applied during the frame-wise audio enhancement. Specifically, the one or more processing parameters may include at least one of band gains for noise management, full-band gains for loudness management, full-band gains for peak limiting, and band gains for timbre management.

In addition to the one or more processing parameters, the metadata may be generated further based on a result of analyzing multiple frames of (e.g., all of) the audio data (e.g., as performed by the long term statistics module 170). Therein, the analysis of multiple frames of the audio data may yield long-term statistics (e.g., file-based statistics) of the audio data and/or one or more audio features of the audio data (e.g., a content type of the audio data, an indication of a capturing environment of the audio data, a signal-to-noise ratio of the audio data, an overall loudness of the audio data, and/or a spectral shape of the audio data, etc.).

Accordingly, the metadata may comprise first metadata (e.g., enhancement metadata) generated based on the one or more processing parameters of the frame-wise audio enhancement (e.g., as generated by the processing statistics module 160) and second metadata (e.g., long-term metadata) generated based on the result of analyzing multiple frames of the audio data (e.g., as generated by the long term statistics module 170). In such case, the first and second metadata may be compiled to obtain compiled metadata as the metadata for output (e.g., as done by the metadata compiler module 180).

At step S240, the enhanced audio data is output together with the generated metadata.

Next, possible implementations of processing the UGC at a replay or editing device will be described with reference to FIG. 3 to FIG. 5.

FIG. 3 illustrates a conceptual diagram of an example apparatus (e.g., device, system) 300 for UGC processing for rendering, such as a general audio rendering system for UGC.

The apparatus 300 comprises a rendering module 310 with a nose management module 320, a loudness management module 330, a timbre management module 340, and a peak limiting module 350. The apparatus 300 only takes the aforementioned enhanced audio data 305 as input and applies blind processing, without the help of any information other than the audio itself. The apparatus 300 finally outputs rendering output 315 for replay. Alternatively, the apparatus 300 may receive but disregard any context metadata that is provided along with the enhanced audio data 305.

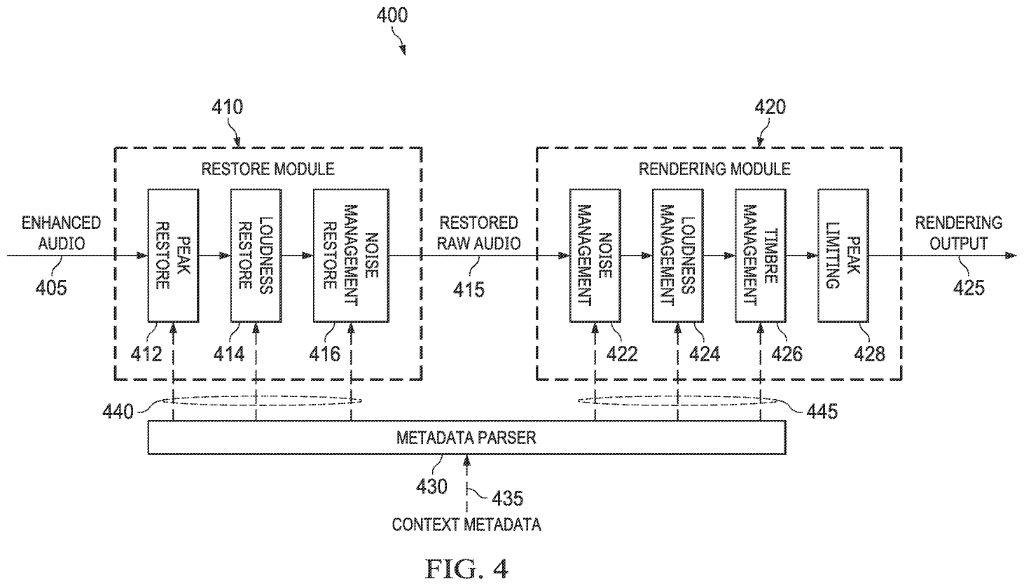

FIG. 4 schematically illustrates an apparatus (e.g., device, system) 400 for processing enhanced audio data 405 relating to UGC (e.g., a rendering apparatus for UGC). Apparatus 400 may relate to a replay side for UGC, and as such may correspond to or be included in a mobile device (e.g., mobile phone, tablet computer, PDA, laptop computer, etc.) or any other computing device. Contrary to the blind processing by apparatus 300, apparatus 400 is configured for context-aware processing of UGC, based on received context metadata.

Thus, in addition to enhanced audio 405 the apparatus 400 also takes the aforementioned context metadata 435 as input, which can be used to steer the rendering processing properly to generate a further enhanced rendering output 425. To this end, the apparatus 400 comprises a metadata parser 430 (e.g., as part of an input module) and several processing components. The processing components in this example may fall into two groups relating to “restore” and “rendering”.

In general, the apparatus 400 may comprise the input module (not shown) for receiving the (enhanced) audio data 405 and the (context) metadata 435 for the audio data, a processing module 410 for applying restore processing the audio data 405, and at least one of a rendering module 420 and an editing module (not shown). For example, the audio data 405 and the metadata 435 may be received in the form of a bitstream comprising the audio data 405 and the metadata 435, including retrieving the audio data 405 and the metadata 435 from a storage medium.

In the example of FIG. 4, the apparatus 400 comprises the metadata parser 430 (e.g., as part of the input module). The metadata parser 430 takes the context metadata 435 (e.g., generated by the aforementioned metadata compiler 180 of apparatus 100) as input.

In line with the above, the metadata 435 comprises first metadata 440 indicative of one or more processing parameters of a previous (earlier, e.g., capture side) frame-wise audio enhancement of the audio data. Additionally or alternatively, the metadata 435 comprises second metadata 445 indicative of long-term statistics of the audio data and/or indicative of one or more audio features of the audio data (e.g., a content type of the audio data, an indication of a capturing environment of the audio data, a signal-to-noise ratio of the audio data prior to the previous frame-wise audio enhancement, an overall loudness of the audio data prior to the previous frame-wise audio enhancement, and/or a spectral shape of the audio data prior to the previous frame-wise audio enhancement, etc.). Therein, the statistics of the audio data and/or the audio features of the audio data could be based on the audio prior to or after the previous frame-wise audio enhancement, or even to audio data between two successive previous frame-wise audio enhancements, if applicable.

The metadata parser 430 retrieves information including processing statistics (e.g., the first metadata 440) and/or long-term statistics (e.g., the second metadata 445), which in turn are used to steer the processing components, such as the restore module 410, the rendering module 420, and/or the editing module.

The “restore” group of processing components generates (restored) raw audio from the enhanced audio with the help of the context metadata 435 (e.g., the first metadata 440). Accordingly, the processing module 410 is configured for applying restore processing to the audio data 405, using the context metadata 435. Specifically, the processing module 410 may use the one or more processing parameters (e.g., as indicated by the first metadata 440), to at least partially reverse the previous frame-wise audio enhancement (as performed on the capture side). Thereby, the processing module 410 obtains (restored) raw audio data 415, which may correspond to or be an approximation of the audio data prior to audio enhancement at the UGC capture side.

Specifically, the processing module 410 may be configured to apply, to the audio data 405, at least one of ambiance restoring, loudness restoring, peak restoring, and timbre restoring.

To this end, the processing module 410 may comprise corresponding ones of a peak restore module (for peak restore), a loudness restore module 414 (for loudness restore), a noise management restore module 416 (for ambience restore), and a timbre management restore module (not shown; for timbre restore). Therein, the individual restore processes may “mirror” the audio enhancement applied at the UGC capture side. They may be applied in the reverse order compared to the processing at the UGC capture side (e.g., as performed by the apparatus 100 shown in FIG. 1). For example, the kind and/or order of the enhancement processing performed on the UGC capture side may be communicated with the metadata 435, with separate metadata, or may have been previously agreed on (e.g., in the context of standardization, etc.).

The peak restore aims to recover the over-suppressed peaks in the enhanced audio 405. The loudness restore seeks to bring the audio level back to the original level, and to remove distortions introduced by the loudness management. The noise management restore (ambience restore) brings back the sound events treated as noise (e.g., engine noise) and leave the decision of suppressing or keeping those events to later processing, or to a content creator using an editing tool. Therein, it is understood that noise management/noise suppression at the UGC capture side may suppress ambiance sound as noise, depending on the definition of “noise” and “ambiance”. Restoring ambiance sound may be desirable especially in those cases in which the suppressed sound relates to a soundscape or the like.

As noted above, the restore processing is based on the one or more processing parameters indicated by the metadata 435 (e.g., by the first metadata 440). As further noted above, the one or more processing parameters may include band gains (e.g., band gains of previous noise management and/or band gains of previous timbre management) and/or full-band gains (e.g., full-band gains of previous loudness management and/or full-band gains of previous peak limiting) applied during the previous frame-wise audio enhancement. Having knowledge of these gains allows to reverse any enhancement processing that has been performed earlier based on these gains.

The rendering module 420 may be configured for applying frame-wise audio enhancement to the (restored) raw audio data 415 to obtain enhanced audio data as the rendering output 425. The “rendering” group of processing components may be the same as those in the example apparatus 100 in FIG. 1 or the example apparatus 300 (example rendering system) in FIG. 3, including noise management, loudness management, timbre management, and peak limiting. Thus, the rendering module 420 may be configured to apply, to the (restored) raw audio data, at least one of noise management (e.g., by a noise management module 422), loudness management (e.g., by a loudness management module 424), timbre management (e.g., by a timbre management module 426), and peak limiting (e.g., by a peak limiting module 428).

The above processing can be steered by the additional information available in the long-term statistics of the context metadata 435. In other words, the rendering module 420 may be configured to apply the frame-wise audio enhancement to the raw audio data 415 based on the second metadata 445.

For example, the noise management may adjust noise suppression applied earlier to the enhanced audio 405, for example to avoid certain over-suppression, keep sound events, or further suppress certain types of noise in the enhanced audio, given the additional information available in the long-term statistics (e.g., indicated by the second metadata 445) of the context metadata 435. The loudness management may level the enhanced audio 405 (or rather, the raw audio 415) to a more appropriate range, given the additional information available in the long-term statistics of the context metadata 435. The timbre management may rebalance the timbre of the audio based on a content analysis, i.e., based on the long-term statistics of the context metadata.

The peak limiting may ensure that the amplitude of the audio after the aforementioned enhancements will not exceed the legitimate range allowed by audio playback.

Alternatively, the restored raw audio 415 obtained by the “restore” group of processing could be exported to an editing tool, where some or all of the processing in the “rendering” group could be applied with controls by a content creator, for example via an editing tool UI, and where additional processing could be applied that is not part of “rendering” group. Accordingly, the editing module may be a module for applying editing processing to the raw audio data to obtain edited audio data. Also the editing may be based on the second metadata 445, for example.

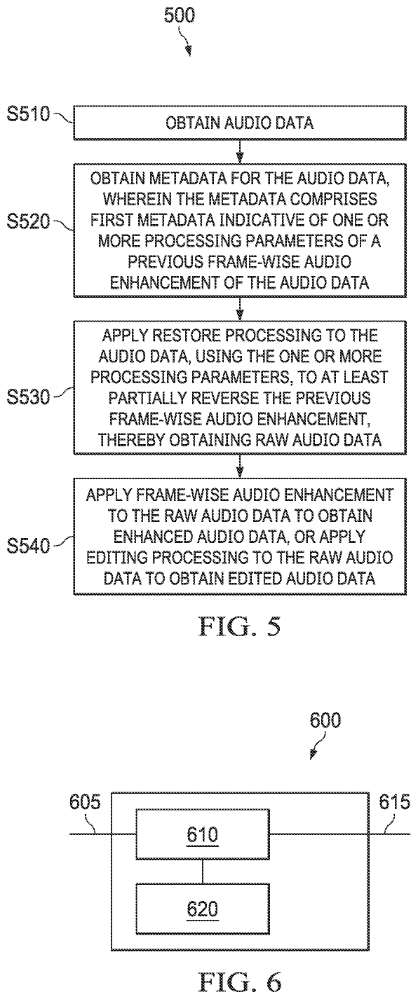

While an example apparatus 400 for UGC processing for rendering/editing has been described above, the present disclosure likewise relates to corresponding methods of UGC processing for rendering/editing. It is understood that any statements made above with regard to the apparatus 400 likewise apply to corresponding methods, and vice versa. An example of such method 500 of UGC processing (i.e., processing of audio data relating to UGC) is illustrated in the flowchart of FIG. 5. Method 500 comprises steps S510 through S540 and may be performed at a playback device (e.g., a mobile device or generic computing device) or editing device.

At step S510, the audio data is obtained. This may comprise or amount to receiving a bitstream comprising the audio data, including retrieving the audio data from a storage medium, for example.

At step S520, metadata for the audio data is obtained. The metadata comprises first metadata indicative of one or more processing parameters of a previous frame-wise audio enhancement of the audio data. Obtaining the metadata may comprise or amount to receiving a bitstream comprising the metadata (e.g., together with the audio data), including retrieving the metadata (e.g., together with the audio data) from a storage medium, for example.

At step S530, restore processing is applied to the audio data, using the one or more processing parameters, to at least partially reverse the previous frame-wise audio enhancement, thereby obtaining raw audio data. For example, applying the restore processing to the audio data may include applying at least one of ambiance restoring, loudness restoring, peak restoring, and timbre restoring.

Accordingly, the one or more processing parameters may include band gains (e.g., band gains of previous noise management and/or band gains of previous timbre management) and/or full-band gains (e.g., full-band gains of previous loudness management and/or full-band gains of previous peak limiting) applied during the previous frame-wise audio enhancement.

This step may proceed in accordance with the processing of the restore module 410 (and its sub-modules) described above.

At step S540, frame-wise audio enhancement is applied to the raw audio data to obtain enhanced audio data, and/or editing processing is applied to the raw audio data to obtain edited audio data.

Here, applying the frame-wise audio enhancement to the raw audio data may be based on second metadata included in the metadata. As described above, the second metadata may be indicative of long-term statistics of the audio data and/or indicative of one or more audio features of the audio data (e.g., a content type of the audio data, an indication of a capturing environment of the audio data, a signal-to-noise ratio of the audio data prior to the previous frame-wise audio enhancement, an overall loudness of the audio data prior to the previous frame-wise audio enhancement, and/or a spectral shape of the audio data prior to the previous frame-wise audio enhancement, etc.).

In analogy to the processing applied by step S220 of method 200 shown in FIG. 2, applying the frame-wise audio enhancement to the raw audio data may include applying at least one of noise management, loudness management, peak limiting, and timbre management.

Step S540 may proceed in accordance with the processing of the rendering module 420 (and its sub-modules) or the editing module described above.

Examples of methods and apparatus for UGC processing according to embodiments of the disclosure have been described above. It is understood that these methods and apparatus may be implemented by appropriate configuration of computing apparatus (e.g., devices, systems). A block diagram of an example of such computing device 600 is schematically illustrated in FIG. 6. The computing device 600 comprises a processor 610 and a memory 620 coupled to the processor 610. The memory 620 stores instructions for the processor 610. The processor 610 is configured to perform the steps of the methods and/or implement the modules of the apparatus described herein.

The present disclosure further relates to computer programs comprising instructions that, when executed by a computing device, cause the computing device (e.g., generic computing device 600) to perform the steps of the methods and/or implement the modules of the apparatus described herein.

The present disclosure further relates to computer-readable storage media storing such computer programs.

### Interpretation

Aspects of the systems described herein may be implemented in an appropriate computer-based sound processing network environment (e.g., server or cloud environment) for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Specifically, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, “content activity detectors” described herein can include one or more electronic processors, one or more computer-readable medium modules, one or more input/output interfaces, and various connections (e.g., a system bus) connecting the various components.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

### Enumerated Example Embodiments

Various aspects and implementations of the present disclosure may also be appreciated from the following enumerated example embodiments (EEEs), which are not claims.

EEE1. A method of processing audio data relating to user generated content, the method comprising: obtaining the audio data; applying frame-wise audio enhancement to the audio data to obtain enhanced audio data; generating metadata for the enhanced audio data, based on one or more processing parameters of the frame-wise audio enhancement; and outputting the enhanced audio data together with the generated metadata.

EEE2. The method according to EEE1, wherein applying the frame-wise audio enhancement to the audio data includes applying at least one of: noise management; loudness management; peak limiting; and timbre management.

EEE3. The method according to EEE1 or EEE2, wherein the one or more processing parameters include band gains and/or full-band gains applied during the frame-wise audio enhancement.

EEE4. The method according to EEE1 or EEE2, wherein the one or more processing parameters include at least one of: band gains for noise management; full-band gains for loudness management; full-band gains for peak limiting; and band gains for timbre management.

EEE5. The method according to any one of EEE1 to EEE4, wherein the frame-wise audio enhancement is applied in real-time.

EEE6. The method according to any one of EEE1 to EEE5, wherein the metadata is generated further based on a result of analyzing multiple frames of the audio data.

EEE7. The method according to EEE6, wherein the analysis of multiple frames of the audio data yields long-term statistics of the audio data.

EEE8. The method according to EEE6 or EEE7, wherein the analysis of multiple frames of the audio data yields one or more audio features of the audio data.

EEE9. The method according to EEE8, wherein the audio features of the audio data relate to at least one of: a content type of the audio data; an indication of a capturing environment of the audio data; a signal-to-noise ratio of the audio data; an overall loudness of the audio data; and a spectral shape of the audio data.

EEE10. The method according to any one of EEE6 to EEE9, wherein the metadata comprises first metadata generated based on the one or more processing parameters of the frame-wise audio enhancement and second metadata generated based on the result of analyzing multiple frames of the audio data; and the method further comprises compiling the first and second metadata to obtain compiled metadata as the metadata for output.

EEE11. A method of processing audio data relating to user generated content, the method comprising: obtaining the audio data; obtaining metadata for the audio data, wherein the metadata comprises first metadata indicative of one or more processing parameters of a previous frame-wise audio enhancement of the audio data; applying restore processing to the audio data, using the one or more processing parameters, to at least partially reverse the previous frame-wise audio enhancement, thereby obtaining raw audio data; and applying frame-wise audio enhancement to the raw audio data to obtain enhanced audio data, or applying editing processing to the raw audio data to obtain edited audio data.

EEE12. The method according to EEE11, wherein applying the restore processing to the audio data includes applying at least one of: ambiance restoring; loudness restoring; peak restoring; and timbre restoring.

EEE13. The method according to EEE11 or EEE12, wherein the one or more processing parameters include band gains and/or full-band gains applied during the previous frame-wise audio enhancement.

EEE14. The method according to EEE11 or EEE12, wherein the one or more processing parameters include at least one of: band gains of previous noise management; full-band gains of previous loudness management; full-band gains of previous peak limiting; and band gains of previous timbre management.

EEE15. The method according to any one of EEE11 to EEE14, wherein the metadata further comprises second metadata indicative of long-term statistics of the audio data and/or indicative of one or more audio features of the audio data.

EEE16. The method according to EEE15, wherein the audio features of the audio data relate to at least one of: a content type of the audio data; an indication of a capturing environment of the audio data; a signal-to-noise ratio of the audio data prior to the previous frame-wise audio enhancement; an overall loudness of the audio data prior to the previous frame-wise audio enhancement; and a spectral shape of the audio data prior to the previous frame-wise audio enhancement.

EEE17. The method according to EEE15 or EEE16, wherein applying the frame-wise audio enhancement to the raw audio data is based on the second metadata.

EEE18. The method according to any one of EEE11 to EEE17, wherein applying the frame-wise audio enhancement to the raw audio data includes applying at least one of: noise management; loudness management; peak limiting; and timbre management.

EEE19. An apparatus for processing audio data relating to user generated content, the apparatus comprising: a processing module for applying frame-wise audio enhancement to audio data to obtain enhanced audio data, and for outputting the enhanced audio data; and an analysis module for generating metadata for the enhanced audio data, based on one or more processing parameters of the frame-wise audio enhancement, and for outputting the metadata.

EEE20. The apparatus according to EEE19, wherein the processing module is configured to apply, to the audio data, at least one of: noise management; loudness management; peak limiting; and timbre management.

EEE21. The apparatus according to EEE19 or EEE20, wherein the one or more processing parameters include band gains and/or full-band gains applied during the frame-wise audio enhancement.

EEE22. The apparatus according to EEE19 or EEE20, wherein the one or more processing parameters include at least one of: band gains for noise management; full-band gains for loudness management; full-band gains for peak limiting; and band gains for timbre management.

EEE23. The apparatus according to any one of EEE19 to EEE22, wherein the processing module is configured to apply frame-wise audio enhancement in real-time.

EEE24. The apparatus according to any one of EEE19 to EEE23, wherein the analysis module is configured to generate the metadata further based on a result of analyzing multiple frames of the audio data.

EEE25. The apparatus according to EEE24, wherein the analysis of multiple frames of the audio data yields long-term statistics of the audio data.

EEE26. The apparatus according to EEE24 or EEE25, wherein the analysis of multiple frames of the audio data yields one or more audio features of the audio data.

EEE27. The apparatus according to EEE26, wherein the audio features of the audio data relate to at least one of: a content type of the audio data; an indication of a capturing environment of the audio data; a signal-to-noise ratio of the audio data; an overall loudness of the audio data; and a spectral shape of the audio data.

EEE28. The apparatus according to any one of EEE24 to EEE27, wherein the analysis module is configured to generate first metadata based on the one or more processing parameters of the frame-wise audio enhancement and to generate second metadata based on the result of analyzing multiple frames of the audio data; and the analysis module is further configured to compile the first and second metadata, to thereby obtain compiled metadata as the metadata for output.

EEE29. An apparatus for processing audio data relating to user generated content, the apparatus comprising: an input module for receiving audio data and metadata for the audio data, wherein the metadata comprises first metadata indicative of one or more processing parameters of a previous frame-wise audio enhancement of the audio data; a processing module for applying restore processing the audio data, using the one or more processing parameters, to at least partially reverse the previous frame-wise audio enhancement, thereby obtaining raw audio data; and at least one of a rendering module and an editing module, wherein the rendering module is a module for applying frame-wise audio enhancement to the raw audio data to obtain enhanced audio data, and the editing module is a module for applying editing processing to the raw audio data to obtain edited audio data.

EEE30. The apparatus according to EEE29, wherein the processing module is configured to apply, to the audio data, at least one of: ambiance restoring; loudness restoring; peak restoring; and timbre restoring.

EEE31. The apparatus according to EEE29 or EEE30, wherein the one or more processing parameters include band gains and/or full-band gains applied during the previous frame-wise audio enhancement.

EEE32. The apparatus according to EEE29 or EEE30, wherein the one or more processing parameters include at least one of: band gains of previous noise management; full-band gains of previous loudness management; full-band gains of previous peak limiting; and band gains of previous timbre management.

EEE33. The apparatus according to any one of EEE29 to EEE32, wherein the metadata further comprises second metadata indicative of long-term statistics of the audio data and/or indicative of one or more audio features of the audio data.

EEE34. The apparatus according to EEE33, wherein the audio features of the audio data relate to at least one of: a content type of the audio data; an indication of a capturing environment of the audio data; a signal-to-noise ratio of the audio data prior to the previous frame-wise audio enhancement; an overall loudness of the audio data prior to the previous frame-wise audio enhancement; and a spectral shape of the audio data prior to the previous frame-wise audio enhancement.

EEE35. The apparatus according to EEE33 or EEE34, wherein the rendering module is configured to apply the frame-wise audio enhancement to the raw audio data based on the second metadata.

EEE36. The apparatus according to any one of EEE29 to EEE35, wherein the rendering module is configured to apply, to the raw audio data, at least one of: noise management; loudness management; peak limiting; and timbre management.

EEE37. An apparatus for processing audio data relating to user generated content, the apparatus comprising a processor and a memory coupled to the processor and storing instructions for the processor, wherein the processor is configured to perform all steps of the method according to any one of EEE1 to EEE18.

EEE38. A computer program comprising instructions that, when executed by a computing device, cause the computing device to perform all steps of the method according to any one of EEE1 to EEE18.

EEE39. A computer-readable storage medium storing the computer program according to EEE38.

1-39. (canceled)

40. A method of processing audio data relating to user generated content, the audio data captured by a capture device, the method comprising:
obtaining the audio data;
applying frame-wise audio enhancement to the audio data to obtain enhanced audio data;
generating metadata for the enhanced audio data, based on one or more processing parameters of the frame-wise audio enhancement; and
outputting the enhanced audio data together with the generated metadata for rendering at a playback device;
wherein the metadata comprises first metadata generated based on the one or more processing parameters of the frame-wise audio enhancement and second metadata generated based on the result of analyzing multiple frames of the audio data; and wherein generating the metadata comprises compiling the first and second metadata to obtain compiled metadata as the metadata for output;
wherein the frame-wise audio enhancement is applied during or immediately following capture of the audio data; and
wherein the analysis of the multiple frames of the audio data yields long-term statistics of the audio data.

41. The method according to claim 40, wherein applying the frame-wise audio enhancement to the audio data includes applying at least one of:
noise management;
loudness management;
peak limiting; and
timbre management.

42. The method according to claim 40 or 41, wherein the one or more processing parameters include band gains and/or full-band gains applied during the frame-wise audio enhancement.

43. The method according to claim 40 or 41, wherein the one or more processing parameters include at least one of:
band gains for noise management;
full-band gains for loudness management;
full-band gains for peak limiting; and
band gains for timbre management.

44. The method according to any preceding claim, wherein the analysis of multiple frames of the audio data yields one or more audio features of the audio data.

45. The method according to claim 44, wherein the audio features of the audio data relate to at least one of:
a content type of the audio data;
an indication of a capturing environment of the audio data;
a signal-to-noise ratio of the audio data;
an overall loudness of the audio data; and
a spectral shape of the audio data.

46. A method of processing audio data relating to user generated content, the method comprising:
obtaining the audio data;
obtaining metadata for the audio data, wherein the metadata comprises first metadata indicative of one or more processing parameters of a previous frame-wise audio enhancement of the audio data, the frame-wise audio enhancement applied during or immediately following the capture of the audio data by a capture device, and second metadata indicative of long-term statistics of the audio data;
applying restore processing to the audio data, using the one or more processing parameters, to at least partially reverse the previous frame-wise audio enhancement, thereby obtaining raw audio data; and
applying frame-wise audio enhancement to the raw audio data to obtain enhanced audio data, or applying editing processing to the raw audio data to obtain edited audio data;
wherein applying the frame-wise audio enhancement to the raw audio data is based on the second metadata.

47. The method according to claim 46, wherein applying the restore processing to the audio data includes applying at least one of:
ambiance restoring;
loudness restoring;
peak restoring; and
timbre restoring.

48. The method according to claim 46 or 47, wherein the one or more processing parameters include band gains and/or full-band gains applied during the previous frame-wise audio enhancement.

49. The method according to claim 46 or 47, wherein the one or more processing parameters include at least one of:
band gains of previous noise management;
full-band gains of previous loudness management;
full-band gains of previous peak limiting; and
band gains of previous timbre management.

50. The method according to any one of claims 46 to 49, wherein the second metadata is indicative of one or more audio features of the audio data.

51. The method according to claim 50, wherein the audio features of the audio data relate to at least one of:
a content type of the audio data;
an indication of a capturing environment of the audio data;
a signal-to-noise ratio of the audio data prior to the previous frame-wise audio enhancement;
an overall loudness of the audio data prior to the previous frame-wise audio enhancement; and
a spectral shape of the audio data prior to the previous frame-wise audio enhancement.

52. The method according to any one of claims 46 to 51, wherein applying the frame-wise audio enhancement to the raw audio data includes applying at least one of:
noise management;
loudness management;
peak limiting; and
timbre management.

53. An apparatus for processing audio data relating to user generated content, the audio data captured by a capture device, the apparatus comprising:
a processing module for applying frame-wise audio enhancement to audio data to obtain enhanced audio data, and for outputting the enhanced audio data, wherein the processing module is configured to apply the frame-wise audio enhancement during or immediately following capture of the audio data; and
an analysis module for generating metadata for the enhanced audio data, based on one or more processing parameters of the frame-wise audio enhancement, and for outputting the metadata; wherein the analysis module is configured to generate the metadata further based on a result of analyzing multiple frames of the audio data, wherein the analysis of multiple frames of the audio data yields long-term statistics of the audio data; and
wherein the analysis module is configured to generate first metadata based on the one or more processing parameters of the frame-wise audio enhancement and to generate second metadata based on the result of analyzing multiple frames of the audio data and to compile the first and second metadata, to thereby obtain compiled metadata as the metadata for output.

54. The apparatus according to claim 53, wherein the processing module is configured to apply, to the audio data, at least one of:
noise management;
loudness management;
peak limiting; and
timbre management.

55. The apparatus according to claim 53 or 54, wherein the one or more processing parameters include band gains and/or full-band gains applied during the frame-wise audio enhancement.

56. The apparatus according to claim 53 or 55, wherein the one or more processing parameters include at least one of:
band gains for noise management;
full-band gains for loudness management;
full-band gains for peak limiting; and
band gains for timbre management.

57. The apparatus according to any of claims 53 to 56, wherein the analysis of multiple frames of the audio data yields one or more audio features of the audio data.

58. The apparatus according to claim 57, wherein the audio features of the audio data relate to at least one of:
a content type of the audio data;
an indication of a capturing environment of the audio data;
a signal-to-noise ratio of the audio data;
an overall loudness of the audio data; and
a spectral shape of the audio data.

59. An apparatus for processing audio data relating to user generated content, the apparatus comprising:
an input module for receiving audio data and metadata for the audio data, wherein the metadata comprises first metadata indicative of one or more processing parameters of a previous frame-wise audio enhancement of the audio data, the previous frame-wise audio enhancement applied during or immediately following the capture of the audio data by a capture device;
the metadata further comprising second metadata indicative of long-term statistics of the audio data;
a processing module for applying restore processing the audio data, using the one or more processing parameters, to at least partially reverse the previous frame-wise audio enhancement, thereby obtaining raw audio data; and
at least one of a rendering module and an editing module,
wherein the rendering module is a module for applying frame-wise audio enhancement to the raw audio data to obtain enhanced audio data, and the editing module is a module for applying editing processing to the raw audio data to obtain edited audio data;
wherein the rendering module is configured to apply the frame-wise audio enhancement to the raw audio data based on the second metadata.

60. The apparatus according to claim 59, wherein the processing module is configured to apply, to the audio data, at least one of:
ambiance restoring;
loudness restoring;
peak restoring; and
timbre restoring.

61. The apparatus according to claim 59 or 60, wherein the one or more processing parameters include band gains and/or full-band gains applied during the previous frame-wise audio enhancement.

62. The apparatus according to claim 59 or 60, wherein the one or more processing parameters include at least one of:
band gains of previous noise management;
full-band gains of previous loudness management;
full-band gains of previous peak limiting; and
band gains of previous timbre management.

63. The apparatus according to any one of claims 59 to 62, wherein the second metadata is indicative of one or more audio features of the audio data.

64. The apparatus according to claim 63, wherein the audio features of the audio data relate to at least one of:
a content type of the audio data;
an indication of a capturing environment of the audio data;
a signal-to-noise ratio of the audio data prior to the previous frame-wise audio enhancement;
an overall loudness of the audio data prior to the previous frame-wise audio enhancement; and
a spectral shape of the audio data prior to the previous frame-wise audio enhancement.

65. The apparatus according to any one of claims 59 to 64, wherein the rendering module is configured to apply, to the raw audio data, at least one of:
noise management;
loudness management;
peak limiting; and
timbre management.

66. An apparatus for processing audio data relating to user generated content, the apparatus comprising a processor and a memory coupled to the processor and storing instructions for the processor, wherein the processor is configured to perform all steps of the method according to any one of claims 40 to 52.

67. A computer program comprising instructions that, when executed by a computing device, cause the computing device to perform all steps of the method according to any one of claims 40 to 52.

68. A computer-readable storage medium storing the computer program according to claim 67.
